(19) United States
(12) Patent Application Publication
(10) Pub. No.: US 2022/0026882 A1
(43) Pub. Date: Jan. 27, 2022

(54) APPLICATION CONFIGURATION METHOD, APPARATUS, SYSTEM OF INDUSTRIAL INTERNET OF THINGS SOLUTION, COMPUTER SOFTWARE PRODUCT, AND READABLE MEDIUM

(71) Applicant: Siemens Aktiengesellschaft, Muenchen (DE)

(72) Inventors: Qi WANG, Wuhan (CN); Jun Jie CHEN, Wuxi (CN); He YU, Wuxi (CN); Wen Jing ZHOU, Wuxi (CN); Hai Tao ZHANG, Beijing (CN); Wan Li MA, Beijing (CN)

(73) Assignee: Siemens Aktiengesellschaft, Muenchen (DE)

(21) Appl. No.: 17/312,062

(22) PCT Filed: Dec. 12, 2018
(86) PCT No.: PCT/CN2018/120703

§ 371 Date: Jun. 9, 2021

(51) Int. Cl. G05B 19/418

(52) U.S. Cl. CPC G05B 19/4185; G05B 19/4183; G05B 19/41865

(57) ABSTRACT

An application configuration method includes: obtaining a resource recommendation prompt from a repository according to a user customized demand of an industrial Internet of Things solution, invoking a resource from a knowledge base or the repository to generate an industrial Internet of Things model, and matching an application installed at an industrial cloud and at an edge device end with a configuration needed by the application; and generating the industrial Internet of Things solution and deploying the matched application to the industrial cloud and the edge device end.

### CROSS-REFERENCE TO RELATED APPLICATION(S)

This application is the national phase under 35 U.S.C. § 371 of PCT International Application No. PCT/CN2018/120703, which has an International filing date of Dec. 12, 2018, the entire contents of which is incorporated herein by reference.

### BACKGROUND

### Field

Embodiments relate to the industrial Internet of Things, and in particular, to an application configuration method, apparatus, and system of an industrial Internet of Things solution, a computer software product, and a readable medium.

### Related Art

An end-to-end solution of the industrial Internet of Things (industrial IoT) needs to collect bottom-layer data to an upper-layer application for development in a development process. In addition, this industrial Internet of Things solution is user-customized. Therefore, the industrial Internet of Things solution generally relates to development of applications at an edge device end and an industrial cloud and integration of and alignment on interfaces of the edge device end and the industrial cloud. Therefore, the solution of the industrial Internet of Things encounters some challenges, including:
collection of bottom-layer data. The bottom-layer data is data of a device on a production line in a factory, and an edge device is an object of collection and is connected to the bottom-layer device.

Customized development is performed on the industrial Internet of Things solution on the industrial cloud, and valuable information is visualized to an end user.

Alignment is performed on data interfaces for data obtaining at the edge device end and application development on the industrial cloud. However, data obtaining at the edge device end and application development on the industrial cloud are separate. However, to obtain a complete solution, data alignment needs to be performed on interfaces for data obtaining at the edge device end and application development on the industrial cloud.

### SUMMARY

An embodiment provides an application configuration method of an industrial Internet of Things solution, including S1, obtaining a resource recommendation prompt from a repository according to a user customized demand of an industrial Internet of Things solution, invoking a resource from a knowledge base or the repository to generate an industrial Internet of Things model, and matching an application installed at an industrial cloud and at an edge device end with a configuration needed by the application; and S2, generating the industrial Internet of Things solution and deploying the matched application to the industrial cloud and the edge device end.

The repository includes:
an industrial cloud application repository, storing a first application for the industrial cloud and/or a prompt for recommending the first application;
an industrial Internet of Things model repository, storing an industrial Internet of Things model and/or a prompt for recommending the industrial Internet of Things model;
an edge device end application workflow template repository, storing a workflow of an edge device end application and/or a prompt for recommending the workflow; and
an edge device end application repository, storing a second application for an edge device end and/or a prompt for recommending the second application.

Further, step S1 further includes the following sub-steps: S11, selecting the first application from the industrial cloud application repository of the repository according to the user customized demand of the industrial Internet of Things solution; S12, generating, based on the first application, a plurality of industrial Internet of Things model combinations corresponding to a plurality of devices associated with the first application, obtaining a first prompt for selecting the industrial Internet of Things model from the industrial Internet of Things model repository according to the user customized demand, and invoking the selected industrial Internet of Things model and a context relationship of the first application of the industrial Internet of Things model from the knowledge base; S13, matching a workflow template from the edge device end application workflow template repository based on the industrial Internet of Things model, the workflow template including a plurality of second applications associated with each other, then matching a second prompt of the second application from the edge device end application repository according to the matched workflow template, and invoking a context relationship, a workflow, and the second application of the industrial Internet of Things model from the knowledge base, where the second application includes a preprocessing application and a data obtaining application; and S14, generating input/output data source configurations of the first application and the second application according to production line context information.

The context scene includes a relationship between the applications and a relationship between the applications and the industrial Internet of Things model.

Further, step S11 further includes the following step: selecting a plurality of first applications from the industrial cloud application repository of the repository according to the user customized demand of the industrial Internet of Things solution and integrating the plurality of first applications into a first application combination.

Further, when the plurality of first applications is integrated into the first application combination in step S11, step S12 further includes the following step: generating, based on each first application, a plurality of industrial Internet of Things model combinations corresponding to a plurality of devices associated with the first application and integrating the plurality of industrial Internet of Things model combinations into an industrial Internet of Things model set.

Further, step S2 further includes the following steps: generating a final industrial Internet of Things solution according to the matched first application and second application, and configurations and workflows needed by the first application and the second application; invoking the matched first application and second application from the industrial cloud application repository and the edge device end application repository or the knowledge base; and respectively deploying the first application and the second application to the industrial cloud and the edge device end.

Further, the application configuration method further includes the following step: S3, updating a model based on the final industrial Internet of Things solution, an application set and a configuration of the application set, and a context scene to the knowledge base for repeated use.

Another embodiment provides an application configuration apparatus of an industrial Internet of Things solution, obtaining a resource recommendation prompt from a repository according to a user customized demand of an industrial Internet of Things solution, invoking a resource from a knowledge base to generate an industrial Internet of Things model, and matching an application installed at an industrial cloud and at an edge device end with a configuration needed by the application; and generating the industrial Internet of Things solution and deploying the matched application to the industrial cloud and the edge device end.

The repository includes:
an industrial cloud application repository, storing a first application for the industrial cloud and/or a prompt for recommending the first application;
an industrial Internet of Things model repository, storing an industrial Internet of Things model and/or a prompt for recommending the industrial Internet of Things model;
an edge device end application workflow template repository, storing a workflow of an edge device end application and/or a prompt for recommending the workflow; and
an edge device end application repository, storing a second application for an edge device end and/or a prompt for recommending the second application.

Further, the application configuration apparatus of an industrial Internet of Things solution further includes: an application configuration apparatus, selecting the first application from the industrial cloud application repository of the repository according to the user customized demand of the industrial Internet of Things solution; and generating, based on the first application, a plurality of industrial Internet of Things model combinations corresponding to a plurality of devices associated with the first application, obtaining a first prompt for selecting the industrial Internet of Things model from the industrial Internet of Things model repository according to the user customized demand, and invoking the selected industrial Internet of Things model and a context relationship of the first application of the industrial Internet of Things model from the knowledge base; an industrial Internet of Things model generation module, matching a workflow template from the edge device end application workflow template repository based on the industrial Internet of Things model, the workflow template including a plurality of second applications associated with each other, then matching a second prompt of the second application from the edge device end application repository according to the matched workflow template, and invoking a context relationship, a workflow, and the second application of the industrial Internet of Things model from the knowledge base, where the second application includes a preprocessing application and a data obtaining application; and an edge device end workflow matching and recommendation module, generating input/output data source configurations of the first application and the second application according to production line context information.

The context scene includes a relationship between the applications and a relationship between the applications and the industrial Internet of Things model.

Further, the application configuration apparatus further selects a plurality of first applications from the industrial cloud application repository of the repository according to the user customized demand of the industrial Internet of Things solution and integrates the plurality of first applications into a first application combination.

Further, the industrial Internet of Things model generation module further generates, based on each first application, a plurality of industrial Internet of Things model combinations corresponding to a plurality of devices associated with the first application and integrates the plurality of industrial Internet of Things model combinations into an industrial Internet of Things model set.

Further, the application configuration apparatus of an industrial Internet of Things solution further includes a solution generation and application deployment module, generating a final industrial Internet of Things solution according to the matched first application and second application, and configurations and workflows needed by the first application and the second application; invoking the matched first application and second application from the industrial cloud application repository and the edge device end application repository or the knowledge base; and respectively deploying the first application and the second application to the industrial cloud and the edge device end.

Further, the application configuration apparatus further includes a knowledge base improvement module 160, updating a model based on the final industrial Internet of Things solution, an application set and a configuration of the application set, and a context scene to the knowledge base for repeated use.

Another embodiment provides an application configuration system of an industrial Internet of Things solution, including: a processor; and a memory coupled to the processor, where the memory has an instruction stored in the memory, the instruction enables the electronic device to execute an action when being executed by the processor, and the action includes: obtaining a resource recommendation prompt from a repository according to a user customized demand of an industrial Internet of Things solution, invoking a resource from a knowledge base or the repository to generate an industrial Internet of Things model, and matching an application installed at an industrial cloud and at an edge device end with a configuration needed by the application; and generating the industrial Internet of Things solution and deploying the matched application to the industrial cloud and the edge device end.

Further, the action further includes: selecting the first application from the industrial cloud application repository of the repository according to the user customized demand of the industrial Internet of Things solution; generating, based on the first application, a plurality of industrial Internet of Things model combinations corresponding to a plurality of devices associated with the first application, obtaining a first prompt for selecting the industrial Internet of Things model from the industrial Internet of Things model repository according to the user customized demand, and invoking the selected industrial Internet of Things model and a context relationship of the first application of the industrial Internet of Things model from the knowledge base; matching a workflow template from the edge device end application workflow template repository based on the industrial Internet of Things model, the workflow template including a plurality of second applications associated with each other, then matching a second prompt of the second application from the edge device end application repository according to the matched workflow template, and invoking a context relationship, a workflow, and the second application of the industrial Internet of Things model from the knowledge base, where the second application includes a preprocessing application and a data obtaining application; and generating input/output data source configurations of the first application and the second application according to production line context information.

Further, the action further includes: selecting a plurality of first applications from the industrial cloud application repository of the repository according to the user customized demand of the industrial Internet of Things solution and integrating the plurality of first applications into a first application combination.

When the plurality of first applications is integrated into the first application combination, the action further includes: generating, based on each first application, a plurality of industrial Internet of Things model combinations corresponding to a plurality of devices associated with the first application and integrating the plurality of industrial Internet of Things model combinations into an industrial Internet of Things model set.

Further, the action further includes: generating a final industrial Internet of Things solution according to the matched first application and second application, and configurations and workflows needed by the first application and the second application; invoking the matched first application and second application from the industrial cloud application repository and the edge device end application repository or the knowledge base; and respectively deploying the first application and the second application to the industrial cloud and the edge device end.

Further, the action further includes: updating a model based on the final industrial Internet of Things solution, an application set and a configuration of the application set, and a context scene to the knowledge base for repeated use.

Another embodiment provides a computer program product, tangibly stored on a computer readable medium and including a computer executable instruction, enabling at least one processor to perform the method in the first embodiment when the computer executable instruction is executed.

Another embodiment provides a computer program, storing thereon a computer executable instruction, enabling at least one processor to perform the method in the first embodiment when the computer executable instruction is executed.

Embodiments may provide an end-to-end industrial Internet of Things solution, which implements that an application for the industrial cloud or the edge device end can be reused and reduces workloads of application development and communication between different parts of an industrial Internet of Things system. Embodiments may be implemented with the aid of domain knowledge, which provides a simple solution, so that applications can be simply connected to each other, and the applications can be deployed in functions without additional development. Embodiments may avoid excessively relying on experts and reduces workloads of providing a production line cloud service.

A repository connection assists an industrial Internet of Things project as the knowledge base, a production line context scene can support recommending a simple process to a user, and the knowledge base may also be updated from a generated final industrial Internet of Things solution.

### BRIEF DESCRIPTION OF THE DRAWINGS

FIG. 1 is an architectural diagram of an application configuration mechanism for an industrial Internet of Things solution according to a specific embodiment;

FIG. 2 is a flowchart of steps of an application configuration method for an industrial

Internet of Things solution according to a specific embodiment;

FIG. 3 is a schematic diagram of an industrial Internet of Things model of an application configuration mechanism for an industrial Internet of Things solution according to a specific embodiment;

FIG. 4 is a schematic diagram of a domain context scene recommended according to a context scene in a knowledge base of an application configuration mechanism for an industrial Internet of Things solution according to a specific embodiment; and

FIG. 5 is a schematic structural diagram of a knowledge base of an application configuration mechanism for an industrial Internet of Things solution according to a specific embodiment.

### DETAILED DESCRIPTION

An embodiment provides an application configuration method of an industrial Internet of Things solution, including S1, obtaining a resource recommendation prompt from a repository according to a user customized demand of an industrial Internet of Things solution, invoking a resource from a knowledge base or the repository to generate an industrial Internet of Things model, and matching an application installed at an industrial cloud and at an edge device end with a configuration needed by the application; and S2, generating the industrial Internet of Things solution and deploying the matched application to the industrial cloud and the edge device end.

The repository includes:
an industrial cloud application repository, storing a first application for the industrial cloud and/or a prompt for recommending the first application;
an industrial Internet of Things model repository, storing an industrial Internet of Things model and/or a prompt for recommending the industrial Internet of Things model;
an edge device end application workflow template repository, storing a workflow of an edge device end application and/or a prompt for recommending the workflow; and
an edge device end application repository, storing a second application for an edge device end and/or a prompt for recommending the second application.

Further, step S1 further includes the following sub-steps: S11, selecting the first application from the industrial cloud application repository of the repository according to the user customized demand of the industrial Internet of Things solution; S12, generating, based on the first application, a plurality of industrial Internet of Things model combinations corresponding to a plurality of devices associated with the first application, obtaining a first prompt for selecting the industrial Internet of Things model from the industrial Internet of Things model repository according to the user customized demand, and invoking the selected industrial Internet of Things model and a context relationship of the first application of the industrial Internet of Things model from the knowledge base; S13, matching a workflow template from the edge device end application workflow template repository based on the industrial Internet of Things model, the workflow template including a plurality of second applications associated with each other, then matching a second prompt of the second application from the edge device end application repository according to the matched workflow template, and invoking a context relationship, a workflow, and the second application of the industrial Internet of Things model from the knowledge base, where the second application includes a preprocessing application and a data obtaining application; and S14, generating input/output data source configurations of the first application and the second application according to production line context information.

The context scene includes a relationship between the applications and a relationship between the applications and the industrial Internet of Things model.

Further, step S11 further includes the following step: selecting a plurality of first applications from the industrial cloud application repository of the repository according to the user customized demand of the industrial Internet of Things solution and integrating the plurality of first applications into a first application combination.

Further, when the plurality of first applications is integrated into the first application combination in step S11, step S12 further includes the following step: generating, based on each first application, a plurality of industrial Internet of Things model combinations corresponding to a plurality of devices associated with the first application and integrating the plurality of industrial Internet of Things model combinations into an industrial Internet of Things model set.

Further, step S2 further includes the following steps: generating a final industrial Internet of Things solution according to the matched first application and second application, and configurations and workflows needed by the first application and the second application; invoking the matched first application and second application from the industrial cloud application repository and the edge device end application repository or the knowledge base; and respectively deploying the first application and the second application to the industrial cloud and the edge device end.

Further, the application configuration method further includes the following step: S3, updating a model based on the final industrial Internet of Things solution, an application set and a configuration of the application set, and a context scene to the knowledge base for repeated use.

Another embodiment provides an application configuration apparatus of an industrial Internet of Things solution, obtaining a resource recommendation prompt from a repository according to a user customized demand of an industrial Internet of Things solution, invoking a resource from a knowledge base to generate an industrial Internet of Things model, and matching an application installed at an industrial cloud and at an edge device end with a configuration needed by the application; and generating the industrial Internet of Things solution and deploying the matched application to the industrial cloud and the edge device end.

The repository includes:
an industrial cloud application repository, storing a first application for the industrial cloud and/or a prompt for recommending the first application;
an industrial Internet of Things model repository, storing an industrial Internet of Things model and/or a prompt for recommending the industrial Internet of Things model;
an edge device end application workflow template repository, storing a workflow of an edge device end application and/or a prompt for recommending the workflow; and
an edge device end application repository, storing a second application for an edge device end and/or a prompt for recommending the second application.

Further, the application configuration apparatus of an industrial Internet of Things solution further includes: an application configuration apparatus, selecting the first application from the industrial cloud application repository of the repository according to the user customized demand of the industrial Internet of Things solution; and generating, based on the first application, a plurality of industrial Internet of Things model combinations corresponding to a plurality of devices associated with the first application, obtaining a first prompt for selecting the industrial Internet of Things model from the industrial Internet of Things model repository according to the user customized demand, and invoking the selected industrial Internet of Things model and a context relationship of the first application of the industrial Internet of Things model from the knowledge base; an industrial Internet of Things model generation module, matching a workflow template from the edge device end application workflow template repository based on the industrial Internet of Things model, the workflow template including a plurality of second applications associated with each other, then matching a second prompt of the second application from the edge device end application repository according to the matched workflow template, and invoking a context relationship, a workflow, and the second application of the industrial Internet of Things model from the knowledge base, where the second application includes a preprocessing application and a data obtaining application; and an edge device end workflow matching and recommendation module, generating input/output data source configurations of the first application and the second application according to production line context information.

The context scene includes a relationship between the applications and a relationship between the applications and the industrial Internet of Things model.

Further, the application configuration apparatus further selects a plurality of first applications from the industrial cloud application repository of the repository according to the user customized demand of the industrial Internet of Things solution and integrates the plurality of first applications into a first application combination.

Further, the industrial Internet of Things model generation module further generates, based on each first application, a plurality of industrial Internet of Things model combinations corresponding to a plurality of devices associated with the first application and integrates the plurality of industrial Internet of Things model combinations into an industrial Internet of Things model set.

Further, the application configuration apparatus of an industrial Internet of Things solution further includes a solution generation and application deployment module, generating a final industrial Internet of Things solution according to the matched first application and second application, and configurations and workflows needed by the first application and the second application; invoking the matched first application and second application from the industrial cloud application repository and the edge device end application repository or the knowledge base; and respectively deploying the first application and the second application to the industrial cloud and the edge device end.

Further, the application configuration apparatus further includes a knowledge base improvement module 160, updating a model based on the final industrial Internet of Things solution, an application set and a configuration of the application set, and a context scene to the knowledge base for repeated use.

Another embodiment provides an application configuration system of an industrial Internet of Things solution, including: a processor; and a memory coupled to the processor, where the memory has an instruction stored in the memory, the instruction enables the electronic device to execute an action when being executed by the processor, and the action includes: obtaining a resource recommendation prompt from a repository according to a user customized demand of an industrial Internet of Things solution, invoking a resource from a knowledge base or the repository to generate an industrial Internet of Things model, and matching an application installed at an industrial cloud and at an edge device end with a configuration needed by the application; and generating the industrial Internet of Things solution and deploying the matched application to the industrial cloud and the edge device end.

Further, the action further includes: selecting the first application from the industrial cloud application repository of the repository according to the user customized demand of the industrial Internet of Things solution; generating, based on the first application, a plurality of industrial Internet of Things model combinations corresponding to a plurality of devices associated with the first application, obtaining a first prompt for selecting the industrial Internet of Things model from the industrial Internet of Things model repository according to the user customized demand, and invoking the selected industrial Internet of Things model and a context relationship of the first application of the industrial Internet of Things model from the knowledge base; matching a workflow template from the edge device end application workflow template repository based on the industrial Internet of Things model, the workflow template including a plurality of second applications associated with each other, then matching a second prompt of the second application from the edge device end application repository according to the matched workflow template, and invoking a context relationship, a workflow, and the second application of the industrial Internet of Things model from the knowledge base, where the second application includes a preprocessing application and a data obtaining application; and generating input/output data source configurations of the first application and the second application according to production line context information.

Further, the action further includes: selecting a plurality of first applications from the industrial cloud application repository of the repository according to the user customized demand of the industrial Internet of Things solution and integrating the plurality of first applications into a first application combination.

When the plurality of first applications is integrated into the first application combination, the action further includes: generating, based on each first application, a plurality of industrial Internet of Things model combinations corresponding to a plurality of devices associated with the first application and integrating the plurality of industrial Internet of Things model combinations into an industrial Internet of Things model set.

Further, the action further includes: generating a final industrial Internet of Things solution according to the matched first application and second application, and configurations and workflows needed by the first application and the second application; invoking the matched first application and second application from the industrial cloud application repository and the edge device end application repository or the knowledge base; and respectively deploying the first application and the second application to the industrial cloud and the edge device end.

Further, the action further includes: updating a model based on the final industrial Internet of Things solution, an application set and a configuration of the application set, and a context scene to the knowledge base for repeated use.

Another embodiment provides a computer program product, tangibly stored on a computer readable medium and including a computer executable instruction, enabling at least one processor to perform the method in the first embodiment when the computer executable instruction is executed.

Another embodiment provides a computer program, storing thereon a computer executable instruction, enabling at least one processor to perform the method in the first embodiment when the computer executable instruction is executed.

Embodiments may provide an end-to-end industrial Internet of Things solution, which implements that an application for the industrial cloud or the edge device end can be reused and reduces workloads of application development and communication between different parts of an industrial Internet of Things system. Embodiments may be implemented with the aid of domain knowledge, which provides a simple solution, so that applications can be simply connected to each other, and the applications can be deployed in functions without additional development. Embodiments may avoid excessively relying on experts and reduces workloads of providing a production line cloud service.

A repository connection assists an industrial Internet of Things project as the knowledge base, a production line context scene can support recommending a simple process to a user, and the knowledge base may also be updated from a generated final industrial Internet of Things solution.

Specific implementations of embodiments are described below with reference to the accompanying drawings.

Embodiments provide an application configuration mechanism for an industrial Internet of Things solution, which may easily obtain a final industrial Internet of Things solution, make an application based on the final Internet of Things solution to be repeatedly used, and accelerate configurations of the edge device end based on a context scene of the application. Embodiments further integrate domain knowledge and reduces reliance on experts, so that an industrial Internet of Things project becomes easier for a non-expert developer.

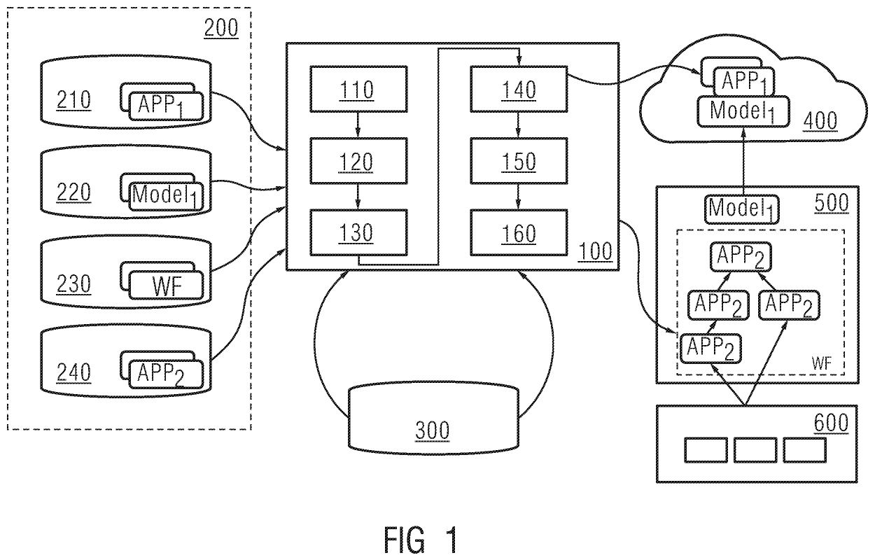

FIG. 1 is an architectural diagram of an application configuration mechanism for an industrial Internet of Things solution. As shown in FIG. 1, an application configuration apparatus 100 is separately coupled to a repository 200, a knowledge base 300, an industrial cloud 400, and an edge device end 500. The repository 200 includes various types of applications, models, and workflows and/or recommendation prompt information of the foregoing various types of applications, models, and workflows. The knowledge base 300 includes a context scene and all information about historical industrial Internet of Things solutions. An edge device is disposed in a factory and is connected to a plurality of production line devices. The edge device is used as an interface of an industrial cloud 400 and a production line and has a function of collecting data. The application configuration apparatus 100 selects a resource from the knowledge base 300 according to a recommendation prompt in the repository 200 and according to a user customized demand, generates a model of the industrial Internet of Things solution, matches an application and a data interface and a parameter of the application, generates a final complete industrial Internet of Things solution, and deploys the application matching the solution to the industrial cloud 400 and the edge device end 500.

The application configuration apparatus 100 is a core module of the embodiments and is configured to extract information from the repository 200 and the knowledge base 300, to generate an end-to-end Internet of Things solution (end-to-end IoT solution), which helps enrich the knowledge base 300. The application configuration mechanism of an industrial Internet of Things solution provided in the embodiments combines applications, industrial Internet of Things models (IoT models), and workflows. Because an application includes an application providing a service to an industrial cloud and implements a function at the edge device end, the embodiments implement connectivity of an industrial Internet of Things system. The application configuration apparatus 100 includes an application selection and combination module 110, an industrial Internet of Things model generation module 120, an edge device end workflow matching and recommendation module 130, a production line scene auxiliary configuration data obtaining module 140, a solution generation and application deployment module 150, and a knowledge base improvement module 160.

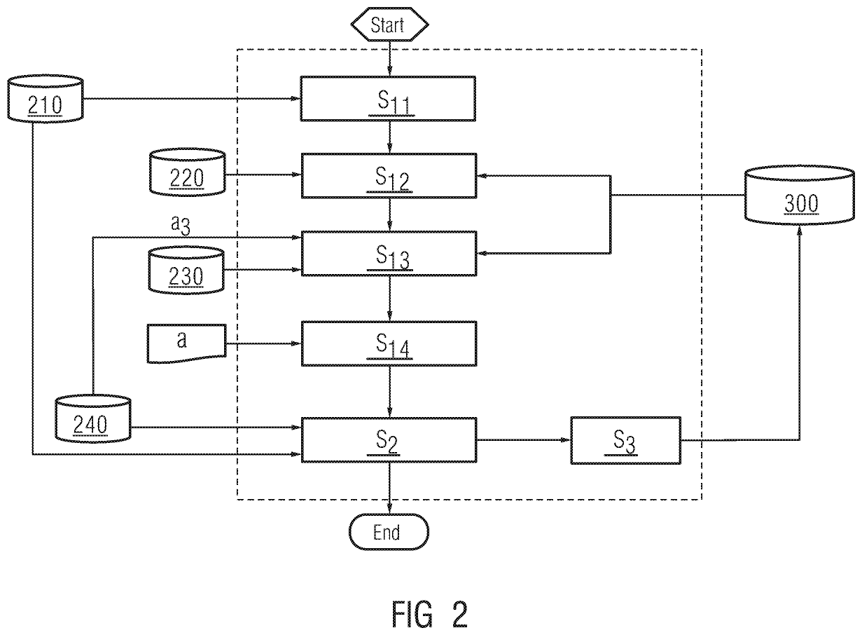

With reference to FIG. 1 and FIG. 2, a first embodiment provides an application configuration method for an industrial Internet of Things solution, including the following steps.

First, perform step S1, obtaining a resource recommendation prompt from a repository 300 according to a user customized demand of an industrial Internet of Things solution, invoking a resource from a knowledge base 300 to generate an industrial Internet of Things model, and matching an application installed at an industrial cloud 400 and at an edge device end 500 with a configuration needed by the application. The industrial Internet of Things solution includes sets, industrial Internet of Things models, and workflows of different applications. The industrial Internet of Things models and the workflows further include a plurality of applications and a mutual relationship between the applications. An architecture of the industrial Internet of Things solution horizontally includes two parts, namely, the industrial cloud 400 and the edge device end 500. The industrial cloud 400 and the edge device end 50 each include a specific or particular industrial Internet of Things model, an application, a workflow, and the like matching an overall solution. The industrial Internet of Things model is related to a plurality of applications, and the industrial Internet of Things model defines data structures of the applications. Once the industrial Internet of Things model is determined, particular specific applications are determined. Therefore, data interfaces to which the particular specific applications correspond can be learned.

Specifically, as shown in FIG. 1, the repository 200 includes an industrial cloud application repository 210, an industrial Internet of Things model repository 220, an edge device end application workflow template repository 230, and an edge device end application repository 240. The industrial cloud application repository 210 stores a first application APP₁ for the industrial cloud and/or a prompt for recommending the first application APP₁. The industrial Internet of Things model repository 220 stores an industrial Internet of Things model model₁ and/or a prompt for recommending the industrial Internet of Things model model₁. The edge device end application workflow template repository 230 stores a workflow WF₁ of the edge device end application and/or a prompt for recommending the workflow WF₁. The edge device end application repository 240 stores a second application APP₂ for the edge device end and/or a prompt for recommending the second application APP₂.

Specifically, step S1 further includes the following sub-steps.

First perform step S11, selecting the first application APP₁ and a parameter needed by the first application APP₁ from the industrial cloud application repository 210 of the repository 200 according to the user customized demand of the industrial Internet of Things solution. Preferably, a plurality of first applications APP₁ is selected from the industrial cloud application repository 210 of the repository 200 according to the user customized demand of the industrial Internet of Things solution, and the plurality of first applications APP₁ is integrated into a first application combination to complete an overall function.

Specifically, the application configuration apparatus 100 includes an application selection and combination module 110, providing a user interface for an end user. The end user may select, through the user interface, the first application APP₁ stored by the industrial cloud in the industrial cloud application repository 210. The application selection and combination module 110 can select the needed first application APP₁ in the existing industrial cloud application repository 210 according to a user's choice or can integrate the plurality of different first applications APP₁ into a first application APP₁ combination to complete an overall function. The parameter needed by the first application APP₁ may be set according to an input of the user in a user interface, and the application selection and combination module 110 may also map the first application APP₁ selected by the user to the needed parameter. The first application APP₁ selected by the user or the integrated first application APP₁ combination is deployed onto the industrial cloud 400 to provide a service to the end user. An input of the application selection and combination module 110 is the user customized demand or user interface input information, and outputs of the application selection and combination module 110 are the selected first application APP₁ or the first application APP₁ combination and the needed parameter thereof. The industrial cloud application repository 210 is used to provide metadata of the selected one or more first applications APP₁.

Preferably, when the plurality of first applications APP₁ is integrated into the first application combination in step S11, step S11 further includes the following step: selecting a plurality of first applications APP₁ from the industrial cloud application repository 210 of the repository according to the user customized demand of the industrial Internet of Things solution and integrating the plurality of first applications APP₁ into a first application combination.

Then perform sub-step S12, generating, based on the first application APP₁, a plurality of industrial Internet of Things model combinations corresponding to a plurality of devices associated with the first application APP₁, obtaining a first prompt for selecting the industrial Internet of Things model from the industrial Internet of Things model repository 220 according to the user customized demand, and invoking the selected industrial Internet of Things model model₁ and a context relationship of the first application APP₁ of the industrial Internet of Things model model₁ from the knowledge base 300. The application configuration apparatus 100 includes an industrial Internet of Things model generation module 120, selecting the first prompt of the industrial Internet of Things model model₁ from the industrial Internet of Things model repository 220 according to the user customized demand. The model is associated with the plurality of first applications APP₁. Specifically, the industrial Internet of Things model generation module 120 queries the industrial Internet of Things model repository 220 and the knowledge base 300 to generate the industrial Internet of Things model model₁ based on the selected one or more first applications APP₁ in step S12. As a premise, the application on which the industrial Internet of Things model in the knowledge base 300 is based is associated with the first application APP₁.

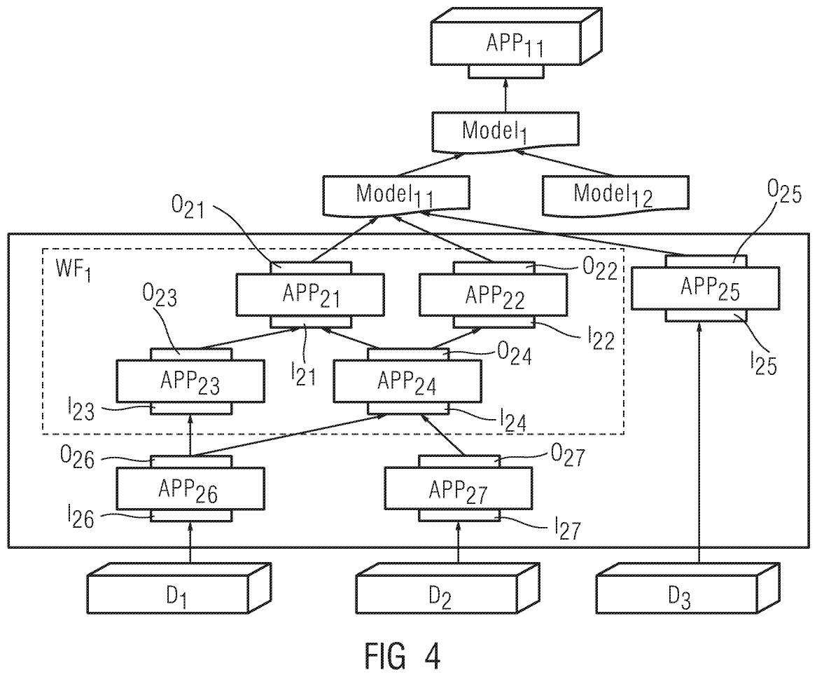

The first application APP₁ manages a plurality of production line devices. One device may have an industrial Internet of Things model model₁. For example, a television has a television model, and a gearbox has a gearbox model. A combination of a plurality of industrial Internet of Things models model₁ of all devices managed by a particular first application APP₁ is recommended in the first prompt of the industrial Internet of Things model repository 220. It should be noted that the application is only associated with the industrial Internet of Things model, but the model needs to be invoked from the repository 200 or the knowledge base 300 according to information about the associated industrial Internet of Things model. Specifically, as shown in FIG. 4, it is assumed that a combination of a plurality of industrial Internet of Things models model₁ of all devices managed by a particular first application APP₁₁ is recommended in the first prompt of the industrial Internet of Things model repository 220, and the industrial Internet of Things models model₁ include industrial Internet of Things models model₁₁ and model₁₂ respectively corresponding to two devices. In this step, the industrial Internet of Things model model₁₁ is selected according to user requirements.

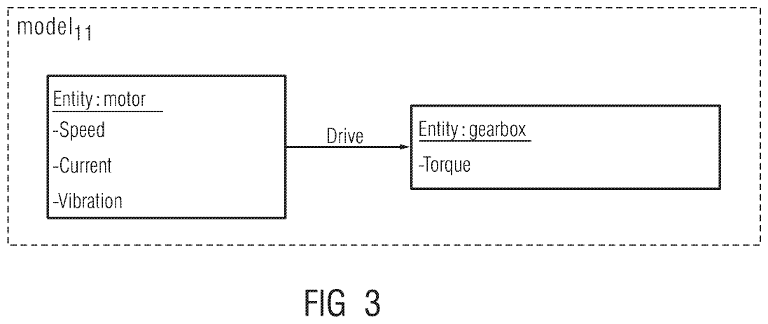

For example, as shown in FIG. 3, the first industrial Internet of Things model model₁₁ includes two entities, one being a motor, and the other being a gearbox. A relationship between the motor and the gearbox is that the motor drives the gearbox. The motor includes a plurality of parameters: speed, current, and vibration. The entity includes one parameter: torque.

Further, when the plurality of first applications APP₁ is integrated into the first application combination in step S11, step S12 includes the following step:
generating, based on each first application APP₁, a plurality of industrial Internet of Things model combinations corresponding to a plurality of devices associated with the first application APP₁ and integrating the plurality of industrial Internet of Things model combinations into an industrial Internet of Things model set.

Inputs of the industrial Internet of Things model generation module 120 include:

1. outputs of the application selection and combination module 110, to be specific, the first application APP₁ or the first application APP₁ combination and a needed parameter thereof, that is, metadata of the first application APP₁ and a needed parameter thereof. Association information of the industrial Internet of Things model and the first application APP₁ is also included in the metadata.

2. the industrial Internet of Things model repository 120, including a plurality of industrial Internet of Things models model₁, where the industrial Internet of Things model model₁ further includes entity information such as an apparatus, a machine, a variable, and an entity parameter.

3. an application context scene of the knowledge base 300. The context scene includes connections between a plurality of applications and a relationship between the applications and the industrial Internet of Things model model₁.

An output of the industrial Internet of Things model generation module 120 is the industrial Internet of Things model model₁ associated with the first application APP₁. The first application APP₁ may be run based on a data structure defined by the industrial Internet of Things model model₁.

Then, perform sub-step S13, matching a workflow template WF from the edge device end application workflow template repository 230 based on the industrial Internet of Things model model₁, the workflow template WF including a plurality of second applications APP₂ associated with each other, then matching a second prompt of the second application APP₂ from the edge device end application repository 230 according to the matched workflow template WF, and invoking a context relationship, a workflow WF, and the second application APP₂ of the industrial Internet of Things model model₁ from the knowledge base 300, where the second application APP₂ includes a preprocessing application and a data obtaining application. The edge device end workflow matching and recommendation module 130 is configured to help, with the aid of the knowledge base 300, the user automatically match and recommend the edge device end second application APP₂. An output of the workflow should match the industrial Internet of Things model model₁ generated in the foregoing step. Different industrial Internet of Things models model₁ should be covered by any one of outputs of the workflow WF and the second application APP₂. After outputs of different industrial Internet of Things models model₁ are filled with an output of the edge device end 500, the first application APP₁ obtains sufficient data to provide a service to the end user.

Specifically, inputs of the edge device end application repository 230 include:

1. the application-based industrial Internet of Things model model₁;

2. a workflow template of the edge device end second application APP₂. The workflow template includes input/output information of the second application APP₂.

3. the edge device end application repository 240, providing metadata of the second application APP₂ and an input/output model; and

4. the workflow WF and a context scene of an application input/output model from the knowledge base 300.

Outputs of the edge device end application repository 230 are the matched workflow WF and second application APP₂ and a context scene thereof.

A workflow W template of the second application APP₂ is a set of workflows predefined for the second application APP₂ of the terminal device end 500. The foregoing template is usually used for a combination of the second applications APP₂ of the terminal device end 500 and can be reused in a new project. A workflow WF includes a plurality of second applications APP₂ and input/output wiring rules of these applications. The workflow WF can be described by using RDF or JSON. FIG. 3 shows an example of a workflow. FIG. 4 is a schematic diagram of a domain context scene recommended according to a context scene in a knowledge base of an application configuration mechanism for an industrial Internet of Things solution. As shown in FIG. 4, the first workflow WF₁ includes four second applications, which are respectively a preprocessing application APP₂₁, a preprocessing application APP₂₂, a preprocessing application APP₂₃, and a preprocessing application APP₂₄. The preprocessing application APP₂₁ has an input interface I₂₁ and an output interface O₂₁. The preprocessing application APP₂₂ has an input interface I₂₂ and an output interface O₂₂. The preprocessing application APP₂₃ has an input interface I₂₃ and an output interface O₂₃. The preprocessing application APP₂₄ has an input interface I₂₄ and an output interface O₂₄. The workflow WF1 further includes a mutual relationship between the foregoing second applications. The mutual relationship includes input/output data streams between the applications, that is, input/output wiring rules. For example, the preprocessing application APP₂₄ needs a motor (a terminal device) to output a calculation result, then outputs a root mean square of the result, and sends the root mean square to the preprocessing application APP₂₂. The preprocessing application APP₂₂ then performs additional processing, for example, outputs statistics of one day, one hour, or the like. The second application of the edge device end 500 further includes a data obtaining application APP₂₅, a data obtaining application APP₂₆, and a data obtaining application APP₂₇. As shown in FIG. 4, the selected industrial Internet of Things model model₁₁ is separately associated with the preprocessing application APP₂₁, the preprocessing application APP₂₂, and the data obtaining application APP₂₅ and is connected to the output interfaces O₂₁, O₂₂, and O₂₅ thereof. The wiring rules of the applications include: the input interface I₂₁ of the preprocessing application APP₂₁ is separately connected to the output interfaces O₂₃ and O₂₄ of the preprocessing application APP₂₃ and the preprocessing application APP₂₄; the input interface I₂₂ of the preprocessing application APP₂₂ is connected to the output interface O₂₄ of the preprocessing application APP₂₄; the output interface O₂₆ of the data obtaining application APP₂₆ is separately connected to input interface I₂₃ of the preprocessing application APP₂₃ and the input interface I₂₄ of the preprocessing application APP₂₄; the output interface O₂₇ of the data obtaining application APP₂₇ is connected to the input interface I₂₄ of the preprocessing application APP₂₄.

Then perform step S14, as shown in FIG. 2, generating input/output data source configurations of the first application APP₁ and the second application APP₂ according to production line context information a. The production line scene auxiliary configuration data obtaining module 140 provides a configuration of the data obtaining second application APP₂ at the edge device end 500, the data obtaining second application APP₂ is linked with a data source of a production line system, and the production line system includes an automation system (such as a PLC) and simulation software. Inputs of the production line scene auxiliary configuration data obtaining module 140 are: the matched workflow WF and second application APP₂; and a production line scene. Outputs of the production line scene auxiliary configuration data obtaining module 140 are: the matched data obtaining second application APP₂; a pre-executed application and workflow WF; and configurations needed by all the foregoing applications.

The application decides that production lines on which data sources need to be collected, and the data sources may be collected from a PLC or from a device on a production line or another apparatus connected to a device. For example, as shown in FIG. 4, the input interface I₂₆ of the data obtaining application APP₂₆ is connected to and collects a data source Di on the production line. The input interface I₂₇ of the data obtaining application APP₂₇ is connected to and collects a data source D₂ on the production line. The input interface I₂₅ of the data obtaining application APP₂₅ is connected to and collects a data source D₃ on the production line.

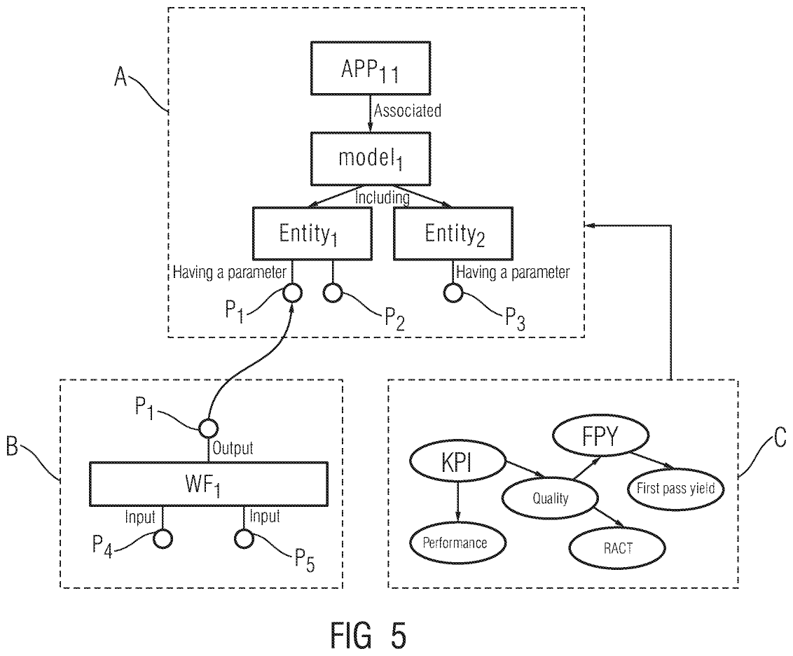

As shown in FIG. 5, the first application APP₁₁ for the industrial cloud 400 is associated with the industrial Internet of Things model model₁. For example, if the first application APP₁₁ is a product key performance indicator (KPI) application, the industrial Internet of Things model model₁ associated with the first application APP₁₁ includes two entities. A first entity Entity₁ is quality, and a second entity Entity₂ is performance. Specifically, the entities all have parameters. The first entity Entity₁ has parameters P₁ and P₂, and the second entity Entity₂ has a parameter P₃. The parameter P₁ is a yield (FPY), the parameter P₂ is the production number (output), and the parameter P₃ is a fulfillment rate. The parameter P₁ is an output of a workflow input/output model B. Specifically, the workflow WF₁ is a yield calculation (FPY calculation) workflow template of the edge device end 500 and has two inputs P₄ and P₅, the input P₄ is a good item, and the input P₅ is a bad item. The knowledge base 300 stores domain knowledge, and recommends a domain context scene according to user requirements. In this embodiment, the recommended domain context scene 3 includes a key performance indicator (KPI), quality, a yield (FPY), performance, real average circle time (RACT), and a first pass yield.

The context scene includes a relationship between the applications and a relationship between the applications and the industrial Internet of Things model.

Then, after step S1, perform step S2, generating the industrial Internet of Things solution and deploying the matched application to the industrial cloud and the edge device end. Specifically, a final industrial Internet of Things solution is generated according to the matched first application APP₁ and second application APP₂, and data interfaces and workflows WF needed by the first application APP₁ and the second application APP₂, and the matched first application APP₁ and second application APP₂ are invoked from the industrial cloud application repository 210 and the edge device end application repository 240. The first application APP₁ and the second application APP₂ are respectively deployed to the industrial cloud 400 and the edge device end 500.

When all the applications are selected, matched, and deployed, the solution generation and application deployment module 150 respectively deploys the first application APP₁ and the second application APP₂ to the industrial cloud 400 and the edge device end 500, to implement the industrial Internet of Things solution. The final industrial Internet of Things solution is the first application APP₁, the second application APP₂, the industrial Internet of Things model model₁, and the workflow WF. The first application APP₁ provides a service to the industrial cloud 400. The second application APP₂ achieves a function at the edge device end 500. These applications are together connected in the industrial Internet of Things system. The inputs of the production line scene auxiliary configuration data obtaining module 140 are: the first application APP₁; the industrial Internet of Things model model₁; the matched data obtaining second application APP₂; a pre-executed second application and workflow WF; the industrial cloud application repository 210; the edge device end application repository 240; and configurations needed by all the foregoing applications. The outputs of the production line scene auxiliary configuration data obtaining module 140 are: one or more first applications APP₁ deployed at the industrial cloud 400; one or more second applications APP₂, a workflow WF, and an application configuration that are deployed at the edge device end 500; the industrial Internet of Things model model₁ disposed at the industrial cloud 400 and the edge device end 500; and all final industrial Internet of Things solution-based related information sent to the knowledge base 300.

At last, perform step S3, updating a model based on the final industrial Internet of Things solution, an application set and a configuration of the application set, and a context scene to the knowledge base 300 for repeated use. The knowledge base improvement module 160 classifies all selection and configuration information generated in the foregoing process as new knowledge and stores the new knowledge in the knowledge base 300. These statistic records in the knowledge base 300 are subsequently updated and are used to provide a better recommendation service. An input of the knowledge base improvement module 160 is the final industrial Internet of Things solution-based related information, including the application and the configuration of the application, the industrial Internet of Things model model₁, and the workflow WF.

The repository 200 includes reusable elements, and the reusable elements are prestored in cloud storage. Each repository is consistent with a service and an application programming interface (API), to obtain or set content. Embodiments include four types of repositories, which represent four types of reusable elements.

The industrial cloud application repository 210 stores the first application APP₁, and the first application APP₁ is a cloud application and includes a set of the first application APP₁ and metadata thereof. The set can be used to start an application in an execution time environment of the first application APP₁. The application provides a service to the end user, and the service includes a network service of a user interface or value-add backend features. Most of the foregoing applications can be tightly bound to the industrial Internet of Things model because the industrial Internet of Things model defines that the application enters a data structure of cloud data.

The industrial Internet of Things model repository 220 includes universal entities, domain entities, and a specific instance of a plant or a machine and includes names, parameters, and relationships between different entities. In addition, the industrial Internet of Things model model₁ defines a data structure and storage of the application. Different applications have different industrial Internet of Things models model₁. The industrial Internet of Things model can be described by using RDF or W3C.

The second application APP₂ exists in the edge device end application repository 240, including a combination of the second application APP₂ and metadata thereof. The combination is used to start an application in a running time environment of the second application APP₂. The foregoing application provides functional execution at the terminal device 500 or a network card. Each second application APP₂ has input and output parameters, and an input end and an output end of the second application APP₂ can be connected and integrated together to provide an overall function. This is the commonest feature of the second application for data obtaining and preprocessing in the terminal device.

Specifically, the knowledge base 300 provides knowledge and storage information, the knowledge can be described by using an RDF format, and a knowledge service provides a query service using an SPARQL language. The first application for the industrial cloud and the industrial Internet of Things model has internal association, the application metadata is associated with the industrial Internet of Things model, and the industrial Internet of Things model includes names and parameters. The workflow of the second application for the edge device end and an input/output model thereof includes an input and an output of the edge device end workflow and names and types of the input and the output. The domain context scene for recommendation is used to connect the workflow of the second application for the edge device end or a single second application to the industrial Internet of Things model having the first application.

A second embodiment provides an application configuration apparatus of an industrial Internet of Things solution, obtaining a resource recommendation prompt from a repository according to a user customized demand of an industrial Internet of Things solution, invoking a resource from a knowledge base to generate an industrial Internet of Things model, and matching an application installed at an industrial cloud and at an edge device end with a configuration needed by the application; and generating the industrial Internet of Things solution and deploying the matched application to the industrial cloud and the edge device end.

The repository includes:
an industrial cloud application repository, storing a first application for the industrial cloud and/or a prompt for recommending the first application;
an industrial Internet of Things model repository, storing an industrial Internet of Things model and/or a prompt for recommending the industrial Internet of Things model;
an edge device end application workflow template repository, storing a workflow of an edge device end application and/or a prompt for recommending the workflow; and
an edge device end application repository, storing a second application for an edge device end and/or a prompt for recommending the second application.

Further, the application configuration apparatus of an industrial Internet of Things solution further includes: an application configuration apparatus, selecting the first application from the industrial cloud application repository of the repository according to the user customized demand of the industrial Internet of Things solution; and generating, based on the first application, a plurality of industrial Internet of Things model combinations corresponding to a plurality of devices associated with the first application, obtaining a first prompt for selecting the industrial Internet of Things model from the industrial Internet of Things model repository according to the user customized demand, and invoking the selected industrial Internet of Things model and a context relationship of the first application of the industrial Internet of Things model from the knowledge base; an industrial Internet of Things model generation module, matching a workflow template from the edge device end application workflow template repository based on the industrial Internet of Things model, the workflow template including a plurality of second applications associated with each other, then matching a second prompt of the second application from the edge device end application repository according to the matched workflow template, and invoking a context relationship, a workflow, and the second application of the industrial Internet of Things model from the knowledge base, where the second application includes a preprocessing application and a data obtaining application; and an edge device end workflow matching and recommendation module, generating input/output data source configurations of the first application and the second application according to production line context information.

The context scene includes a relationship between the applications and a relationship between the applications and the industrial Internet of Things model.

Further, the application configuration apparatus further selects a plurality of first applications from the industrial cloud application repository of the repository according to the user customized demand of the industrial Internet of Things solution and integrates the plurality of first applications into a first application combination.

Further, the industrial Internet of Things model generation module further generates, based on each first application, a plurality of industrial Internet of Things model combinations corresponding to a plurality of devices associated with the first application and integrates the plurality of industrial Internet of Things model combinations into an industrial Internet of Things model set.

Further, the application configuration apparatus of an industrial Internet of Things solution further includes a solution generation and application deployment module, generating a final industrial Internet of Things solution according to the matched first application and second application, and configurations and workflows needed by the first application and the second application; invoking the matched first application and second application from the industrial cloud application repository and the edge device end application repository or the knowledge base; and respectively deploying the first application and the second application to the industrial cloud and the edge device end.

Further, the application configuration apparatus further includes a knowledge base improvement module 160, updating a model based on the final industrial Internet of Things solution, an application set and a configuration of the application set, and a context scene to the knowledge base for repeated use.

A third embodiment provides an application configuration system of an industrial Internet of Things solution, including: a processor; and a memory coupled to the processor, where the memory has an instruction stored in the memory, the instruction enables the electronic device to execute an action when being executed by the processor, and the action includes: obtaining a resource recommendation prompt from a repository according to a user customized demand of an industrial Internet of Things solution, invoking a resource from a knowledge base or the repository to generate an industrial Internet of Things model, and matching an application installed at an industrial cloud and at an edge device end with a configuration needed by the application; and generating the industrial Internet of Things solution and deploying the matched application to the industrial cloud and the edge device end.

Further, the action further includes: selecting the first application from the industrial cloud application repository of the repository according to the user customized demand of the industrial Internet of Things solution; generating, based on the first application, a plurality of industrial Internet of Things model combinations corresponding to a plurality of devices associated with the first application, obtaining a first prompt for selecting the industrial Internet of Things model from the industrial Internet of Things model repository according to the user customized demand, and invoking the selected industrial Internet of Things model and a context relationship of the first application of the industrial Internet of Things model from the knowledge base; matching a workflow template from the edge device end application workflow template repository based on the industrial Internet of Things model, the workflow template including a plurality of second applications associated with each other, then matching a second prompt of the second application from the edge device end application repository according to the matched workflow template, and invoking a context relationship, a workflow, and the second application of the industrial Internet of Things model from the knowledge base, where the second application includes a preprocessing application and a data obtaining application; and generating input/output data source configurations of the first application and the second application according to production line context information.

Further, the action further includes: selecting a plurality of first applications from the industrial cloud application repository of the repository according to the user customized demand of the industrial Internet of Things solution and integrating the plurality of first applications into a first application combination.
when the plurality of first applications is integrated into the first application combination, the action further includes: generating, based on each first application, a plurality of industrial Internet of Things model combinations corresponding to a plurality of devices associated with the first application and integrating the plurality of industrial Internet of Things model combinations into an industrial Internet of Things model set.

Further, the action further includes: generating a final industrial Internet of Things solution according to the matched first application and second application, and configurations and workflows needed by the first application and the second application; invoking the matched first application and second application from the industrial cloud application repository and the edge device end application repository or the knowledge base; and respectively deploying the first application and the second application to the industrial cloud and the edge device end.

Further, the action further includes: updating a model based on the final industrial Internet of Things solution, an application set and a configuration of the application set, and a context scene to the knowledge base for repeated use.

A fourth embodiment further provides a computer program product, tangibly stored on a computer readable medium and including a computer executable instruction, enabling at least one processor to perform the method in the first embodiment when the computer executable instruction is executed.

A fifth embodiment provides a computer program, storing thereon a computer executable instruction, enabling at least one processor to perform the method in the first embodiment when the computer executable instruction is executed.

Advantages of embodiments lie in providing an end-to-end industrial Internet of Things solution, which implements that an application for the industrial cloud or the edge device end can be reused and reduces workloads of application development and communication between different parts of an industrial Internet of Things system. The embodiments are implemented with the aid of domain knowledge, which provides a simple solution, so that applications can be simply connected to each other, and the applications can be deployed in functions without additional development. Embodiments avoids excessively relying on experts and reduces workloads of providing a production line cloud service.

A repository connection provided in the embodiments assist an industrial Internet of Things project as the knowledge base, a production line context scene can support recommending a simple process to a user, and the knowledge base may also be updated from a generated final industrial Internet of Things solution.

Although the content of the present disclosure is described in detail through the foregoing preferred embodiments, it should be learned that the foregoing description should not be considered as a limitation on the embodiments. After a person skilled in the art reads the foregoing content, various modifications and replacements of the embodiments would be obvious. Therefore, the protection scope of the present disclosure should be limited by the appended claims. In addition, any reference numeral in the claims should not be considered as a limitation on the involved claim. A word “include” does not exclude apparatuses or steps not listed in other claims or in the specification; words such as “first” and “second” are only used to represent names and do not indicate any particular sequence.

1. An application configuration method of an industrial Internet of Things solution, the application configuration method comprising:
obtaining a resource recommendation prompt from a repository according to a user customized demand of the industrial Internet of Things solution:
invoking a resource from a knowledge base or the repository to generate an industrial Internet of Things model;
matching an application installed at an industrial cloud and at an edge device end with a configuration needed by the application;
generating the industrial Internet of Things solution; and
deploying the matched application to the industrial cloud and the edge device end.

2. The application configuration method according to claim 1, wherein the repository comprises at least one of:
an industrial cloud application repository, storing at least one of a first application for the industrial cloud or a prompt for recommending the first application;
an industrial Internet of Things model repository, storing at least one of an industrial Internet of Things model or a prompt for recommending the industrial Internet of Things model;
an edge device end application workflow template repository, storing at least one of a workflow of an edge device end application or a prompt for recommending the workflow; or
an edge device end application repository, storing at least one of a second application for an edge device end or a prompt for recommending the second application.

3. The application configuration method according to claim 2, further comprising:
selecting the first application from the industrial cloud application repository according to the user customized demand of the industrial Internet of Things solution;
generating, based on the first application, a plurality of industrial Internet of Things model combinations corresponding to a plurality of devices associated with the first application;
obtaining a first prompt for selecting the industrial Internet of Things model from the industrial Internet of Things model repository according to the user customized demand;
invoking a selected industrial Internet of Things model and a context relationship of the first application of the industrial Internet of Things model from the knowledge base;
matching a workflow template from the edge device end application workflow template repository based on the selected industrial Internet of Things model, the workflow template including a plurality of second applications associated with each other;
matching a second prompt of the second application from the edge device end application repository according to the workflow template;
invoking a context relationship, a workflow, and the second application of the industrial Internet of Things model from the knowledge base, wherein
the second application includes a preprocessing application and a data obtaining application; and
generating input/output data source configurations of the first application and the second application according to production line context information.

4. The application configuration method according to claim 3, wherein the knowledge base includes a context scene including a relationship between applications and a relationship between the applications and the industrial Internet of Things model.

5. The application configuration method according to claim 3, further:
selecting a plurality of first applications from the industrial cloud application repository according to the user customized demand of the industrial Internet of Things solution; and
integrating the plurality of first applications into a first application combination.

6. The application configuration method according to claim 5, wherein when the plurality of first applications is integrated into the first application combination the application configuration method further comprises:
generating, based on each first application, a plurality of industrial Internet of Things model combinations corresponding to a plurality of devices associated with the first application; and
integrating the plurality of industrial Internet of Things model combinations into an industrial Internet of Things model set.

7. The application configuration method according to claim 2, further comprising:
generating a final industrial Internet of Things solution according to a matched first application and second application, and configurations and workflows needed by the matched first application and the second application;
invoking the matched first application and second application from the industrial cloud application repository and the edge device end application repository or the knowledge base; and
respectively deploying the matched first application and the second application to the industrial cloud and the edge device end.

8. The application configuration method according to claim 7, further comprising:
updating a model based on the final industrial Internet of Things solution, an application set and a configuration of the application set, and a context scene to the knowledge base for repeated use.

9. An application configuration apparatus of an industrial Internet of Things solution, the application configuration apparatus configured to
obtain a resource recommendation prompt from a repository according to a user customized demand of the industrial Internet of Things solution,
invoke a resource from a knowledge base to generate an industrial Internet of Things model,
match an application installed at an industrial cloud and at an edge device end with a configuration needed by the application,
generate the industrial Internet of Things solution, and
deploy the matched application to the industrial cloud and the edge device end.

10. The application configuration apparatus of an industrial Internet of Things solution according to claim 9, wherein the repository comprises at least one of:
an industrial cloud application repository, storing at least one of a first application for the industrial cloud or a prompt for recommending the first application;
an industrial Internet of Things model repository, storing at least one of an industrial Internet of Things model or a prompt for recommending the industrial Internet of Things model;
an edge device end application workflow template repository, storing at least one of a workflow of an edge device end application or a prompt for recommending the workflow;
an edge device end application repository, storing at least one of a second application for an edge device end or a prompt for recommending the second application.

11. The application configuration apparatus of an industrial Internet of Things solution according to claim 10, further comprising:
an application configuration apparatus configured to
select the first application from the industrial cloud application repository according to the user customized demand of the industrial Internet of Things solution,
generate, based on the first application, a plurality of industrial Internet of Things model combinations corresponding to a plurality of devices associated with the first application,
obtain a first prompt for selecting the industrial Internet of Things model from the industrial Internet of Things model repository according to the user customized demand, and
invoke a selected industrial Internet of Things model and a context relationship of the first application of the industrial Internet of Things model from the knowledge base; an industrial Internet of Things model generation module, configured to
match a workflow template from the edge device end application workflow template repository based on the selected industrial Internet of Things model, the workflow template including a plurality of second applications associated with each other,
match a second prompt of the second application from the edge device end application repository according to the workflow template, and
invoke a context relationship, a workflow, and the second application of the industrial Internet of Things model from the knowledge base, wherein
the second application includes a preprocessing application and a data obtaining application; and
an edge device end workflow matching and recommendation module, configured to generate input/output data source configurations of the first application and the second application according to production line context information.

12. The application configuration apparatus of an industrial Internet of Things solution according to claim 11, wherein the knowledge base includes context scene including a relationship between applications and a relationship between the applications and the industrial Internet of Things model.

13. The application configuration apparatus of an industrial Internet of Things solution according to claim 11, wherein the application configuration apparatus is configured to select a plurality of first applications from the industrial cloud application repository according to the user customized demand of the industrial Internet of Things solution, and integrate the plurality of first applications into a first application combination.

14. The application configuration apparatus of an industrial Internet of Things solution according to claim 13, wherein the industrial Internet of Things model generation module is configured to
generate, based on each first application, a plurality of industrial Internet of Things model combinations corresponding to a plurality of devices associated with the first application, and
integrate the plurality of industrial Internet of Things model combinations into an industrial Internet of Things model set.

15. The application configuration apparatus of an industrial Internet of Things solution according to claim 10, wherein the application configuration apparatus of an industrial Internet of Things solution further comprises:
a solution generation and application deployment module, configured to
generate a final industrial Internet of Things solution according to a matched first application and second application, and configurations and workflows needed by the matched first application and the second application,
invoke the matched first application and second application from the industrial cloud application repository and the edge device end application repository or the knowledge base; and
respectively deploy the matched first application and the second application to the industrial cloud and the edge device end.

16. The application configuration apparatus of an industrial Internet of Things solution according to claim 15, wherein the application configuration apparatus comprises:
a knowledge base improvement module configured to update a model based on the final industrial Internet of Things solution, an application set and a configuration of the application set, and a context scene to the knowledge base for repeated use.

17. An application configuration system of an industrial Internet of Things solution, the application configuration system comprising:
at least one processor; and
a memory coupled to the at least one processor, the memory storing instructions enabling the application configuration system the execute actions when executed by the at least one processor, the actions including
obtaining a resource recommendation prompt from a repository according to a user customized demand of the industrial Internet of Things solution,
invoking a resource from a knowledge base or the repository to generate an industrial Internet of Things model,
matching an application installed at an industrial cloud and at an edge device end with a configuration needed by the application,
generating the industrial Internet of Things solution, and
deploying the matched application to the industrial cloud and the edge device end.

18. The application configuration system of an industrial Internet of Things solution according to claim 17, wherein the actions further comprise:
selecting a first application from an industrial cloud application repository according to the user customized demand of the industrial Internet of Things solution;
generating, based on the first application, a plurality of industrial Internet of Things model combinations corresponding to a plurality of devices associated with the first application;
obtaining a first prompt for selecting the industrial Internet of Things model from an industrial Internet of Things model repository according to the user customized demand;
invoking a selected industrial Internet of Things model and a context relationship of the first application of the industrial Internet of Things model from the knowledge base;
matching a workflow template from an edge device end application workflow template repository based on the selected industrial Internet of Things model, the workflow template including a plurality of second applications associated with each other;
matching a second prompt of the second application from an edge device end application repository according to the workflow template;
invoking a context relationship, a workflow, and the second application of the industrial Internet of Things model from the knowledge base, wherein
the second application comprises a preprocessing application and a data obtaining application; and
generating input/output data source configurations of the first application and the second application according to production line context information.

19. The application configuration system of an industrial Internet of Things solution according to claim 18, wherein the actions further comprise:
selecting a plurality of first applications from the industrial cloud application repository according to the user customized demand of the industrial Internet of Things solution and
integrating the plurality of first applications into a first application combination.

20. The application configuration system of an industrial Internet of Things solution according to claim 19, wherein when the plurality of first applications is integrated into the first application combination, the actions further comprise:
generating, based on each first application, a plurality of industrial Internet of Things model combinations corresponding to a plurality of devices associated with the first application: and
integrating the plurality of industrial Internet of Things model combinations into an industrial Internet of Things model set.

21. The application configuration system of an industrial Internet of Things solution according to claim 18, wherein the actions further comprise:
generating a final industrial Internet of Things solution according to matched first application and second application, and configurations and workflows needed by the matched first application and the second application;
invoking the matched first application and second application from the industrial cloud application repository and the edge device end application repository or the knowledge base; and
respectively deploying the matched first application and the second application to the industrial cloud and the edge device end.

22. The application configuration system of an industrial Internet of Things solution according to claim 21, wherein the actions further comprise:
updating a model based on the final industrial Internet of Things solution, an application set and a configuration of the application set, and a context scene to the knowledge base for repeated use.

23. A computer program product, stored on a non-transitory computer readable medium and including a computer executable instruction that enables at least one processor to perform the method according to claim 1 when the computer executable instruction is executed by the at least one processor.

24. A non-transitory computer-readable storage medium storing a computer program including a computer executable instruction that enables at least one processor to perform the method according to claim 1 when the computer executable instruction is executed by the at least on processor.
